(19) United States
(12) Patent Application Publication
(10) Pub. No.: US 2015/0248975 A1
(43) Pub. Date: Sep. 3, 2015

(54) Connecting Device

(71) Applicant: ABB TECHNOLOGY AG, Zurich (CH)

(72) Inventor: Alessandro Bonfanti, Alzano Lombardo (IT)

(21) Appl. No.: 14/430,077

(22) PCT Filed: Sep. 20, 2012
(86) PCT No.: PCT/EP2012/068558

§ 371 Date: Mar. 20, 2015

(51) Int. Cl. H01H 9/28

(52) U.S. Cl. CPC H01H 9/285

(57) ABSTRACT

A connecting device suitable for connecting a movable conducting terminal of a switching device to a stationary conducting terminal of a switchgear apparatus, includes: a pin-group suitable for being inserted into an opening obtained in a connection-region which is defined by mutually overlapping portions of the movable and stationary conducting terminals. The pin-group is movable from a releasing position to a locking-clamping-position. There is provided a locking-positioning-arrangement configured for keeping the pressing-clamping-end blocked in the locking-clamping-position and for imparting to the pressing-clamping-end, upon a movement of the pin-group from the releasing position to the locking-clamping-position, a tightening displacement so as to generate a tightening force which presses the mutually overlapping portions against to one other. The connecting device is provided with a tightening-control-arrangement configured for controlling the tightening force so as to set a desired value of tightening-contact-pressure between the mutually overlapping portions.

### FIELD OF THE INVENTION

The present disclosure relates to a connecting device suitable for connecting a movable conducting terminal of a switching device, in particular of a circuit-breaker, to a stationary conducting terminal of a switchgear apparatus.

### BACKGROUND OF THE INVENTION

In the medium voltage field, it is known that the connection of movable busbar terminals of a circuit breaker to respective stationary busbar terminals of a switchgear is achieved according to different possible types of connection as described in the following. According to a first type of connection, bolts and nuts are used to mutually fasten the movable and stationary busbar terminals. Such a first type of connection proves to perform in a quite satisfying way as far as reliability and safety requirements are concerned, owing to the rather simplified structural configuration. However, such a type of connection is rather wearisome to be established, since the screwing operations take a long time and furthermore, for a correct and safe functioning, there is the need for controlling, for each nut-bolt pair, the correct tightening torque. Furthermore, there is also the need for arranging a suitable locking washer on each nut-bolt pair in order to firmly block the latter and thus prevent an undesired loosening in the connection during operation. This last step further makes the overall assembling and connection/disconnection procedure rather difficult and time-consuming.

A second and a third types of connection are also known which are based on so-called tulips-contacts and on so-called pliers-contacts respectively. A screwing-driving-mechanism is associated with these types of connection, for inserting the circuit-breaker in the operative contact position and for extracting it in a non-operative separated position. The tulips-contacts and the pliers-contact provide a connection/disconnection procedure which is faster and easier to perform compared with the use of nuts-bolts. However, there is the need to guarantee and adjust a perfect spatial relationship between the screwing-driving-mechanism and the tulips-contacts or the pliers-contact in order to ensure a correct alignment, and thus a successful mutual engagement, of the movable busbar terminals with the stationary busbar terminals. Therefore, with these types of connection, high levels of precision are required during both the assembling procedure and the service life of the switchgear.

### SUMMARY OF THE INVENTION

Although the above described connection systems perform in a quite satisfying way, there is still room for further improvements. In particular, it would be desirable to provide a technical solution which makes possible to obtain a connection between the busbars which is easy, structurally simple, safe and reliable at the same time.

This is achieved by a connecting device as defined in the appended claims and described hereinafter in details.

According to the disclosure, there is provided a connecting device suitable for connecting a movable conducting terminal of a switching device to a stationary conducting terminal of a switchgear apparatus, comprising:

a pin-group suitable for being inserted into an opening obtained in a connection-region which is defined by mutually overlapping portions of said movable and stationary conducting terminals,

said pin-group having a head-end and a pressing-clamping-end which are suitable for being positioned at opposite sides with respect to said connection-region, said pin-group being movable from a releasing position, in which a mutual separation of said movable and stationary conducting terminals is enabled, to a locking-clamping-position, in which said movable and stationary conducting terminals are reciprocally clamped, wherein it further comprises

a locking-positioning-arrangement configured for keeping said pressing-clamping-end blocked in said locking-clamping-position and for imparting to said pressing-clamping-end, upon a movement of said pin-group from said releasing position to said locking-clamping-position, a tightening displacement so as to generate a tightening force which presses said mutually overlapping portions against to one other, and

a tightening-control-arrangement configured for controlling said tightening force so as to set a desired value of tightening-contact-pressure between said mutually overlapping portions.

Owing to the disclosure, a connecting device is provided which is structurally simple and cheap to be obtained, easy to be used and able to provide in an extremely quick way a safe and reliable electrical connection.

In particular, owing to the connecting device according to the invention, a fast connection/disconnection of an electric power equipment can be achieved with no need for torque-controlling-procedure, as required by the prior art nut-bolts connection, or complicated positioning and coupling driving mechanism as required by the prior art pliers/tulips connecting systems.

The present disclosure encompasses also a switching device, in particular a circuit breaker, comprising one or more conducting terminals and one or more connecting devices as defined in the related appended claims and described herein, and also an electric switchgear, equivalently called with the term panel or cabinet or switchboard, including such a circuit breaker.

Characteristics and advantages of the present disclosure will result from the description and from claims.

### BRIEF DESCRIPTION OF THE DRAWINGS

The present disclosure can be better understood and implemented with reference to the attached drawings that illustrate an embodiment thereof by way of non-limiting examples, in which:

FIG. 1 is an exploded view of a first version of connecting device according to the present disclosure;

FIGS. 2 and 2′ are perspective views of two different versions respectively of a part of the connecting device shown in FIG. 1;

FIG. 3 is a perspective view of a further part of the connecting device shown in FIG. 1;

FIGS. 4 and 5 show the connecting device of FIG. 1 in a releasing position and in a locking-clamping position respectively;

FIG. 6 is an exploded view of a second version of connecting device according to the present disclosure;

FIGS. 7, 8, and 9 are a top view, a bottom view and a side view of a part of the connecting device in FIG. 6;

FIGS. 10 to 13 are different views of a third version of connecting device according to the invention; and

FIGS. 14 and 15 show a switchgear with a circuit breaker, whose busbar terminals are mutually connected by connecting devices according to the invention.

### DETAILED DESCRIPTION OF THE INVENTION

With reference to the attached Figures, a connecting device 1 is shown, which is particularly suitable to be used in the Medium Voltage field, where, for the purposes of the present application, the term medium voltage refers to applications in the range from 1 kV up to some tens of kV, e.g. 52 kV. The connecting device 1 is usable for mutually connecting a movable conducting terminal 2 of a switching device 3 to a stationary conducting terminal 4 provided inside a switchgear apparatus 5 into which the switching device 3 is to be housed. In particular, the movable 2 and stationary 4 conducting terminals are for example of the busbar type made of copper, and the switching device may comprise a removable circuit breaker 3.

The connecting device 1 is configured to clamp together a first portion and a second portion of the movable 2 and stationary 4 conducting terminals respectively, which are mutually overlapped so as to define a connection-region 10 through which an opening 7 is obtained. In particular, the opening 7 is a through-opening which results from adjacent through-holes obtained on the first and second portions.

The connecting device 1 comprises a pin-group 6 provided with a head-end 8 and with a pressing-clamping end 9, which, during operation, are positioned at opposite sides with respect to the connection-region 10. The pin-group 6 is suitable for being inserted into the through-opening 7, and is movable from a releasing position 15, in which a mutual separation of the movable 2 and stationary 4 conducting terminals is enabled, to a locking-clamping-position 16, in which the movable 2 and stationary 4 conducting terminals are reciprocally clamped and locked.

In particular, the pin-group 6 comprises a pin-body including a stem-portion 12, having a longitudinal axis 11, which is suitable for being housed into the through-opening 7. The pin-body is intended to be positioned with the longitudinal axis 11 substantially parallel to an axis of the through-opening 7. In this position, a clamping direction is defined which is transversely, i.e. non-parallel, and in particular for example orthogonal to the surfaces of the first and second portion which are in contact with one other.

The pressing-clamping end 9 comprises a pressing-protrusion-arrangement 18 extending transversely with respect to the longitudinal axis 11. In the exemplary embodiment illustrated, the pressing-protrusion-arrangement comprises two pressing-protrusions 18, extending transversely from the pin-body in opposite directions, and mutually aligned along a common extending direction.

In particular the two pressing-protrusions 18 have a cylindrical shape and are arranged orthogonally to the longitudinal axis 11. The pressing-protrusions 18, for example, can be provided on the pin-body through screwing-couplings.

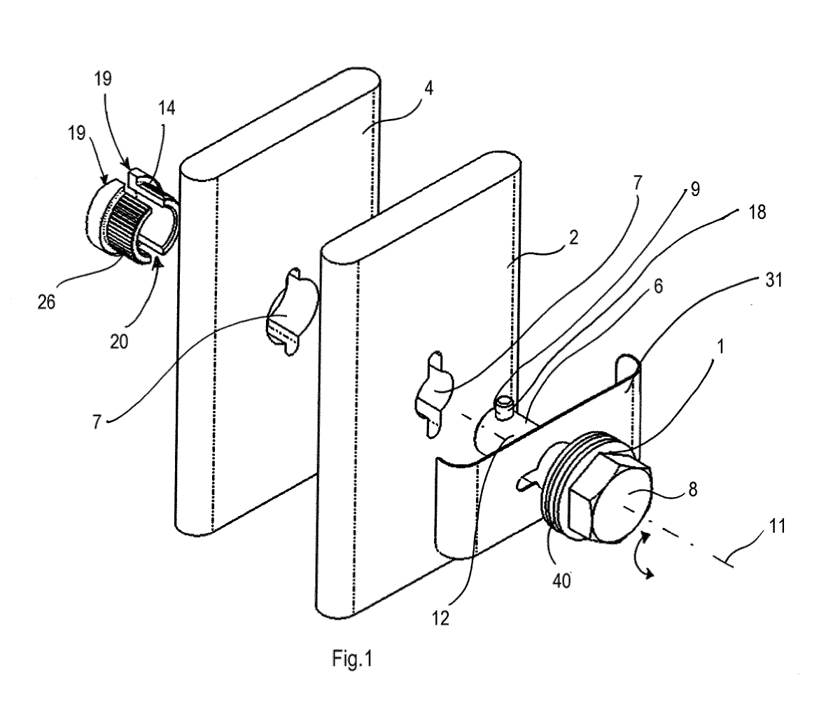

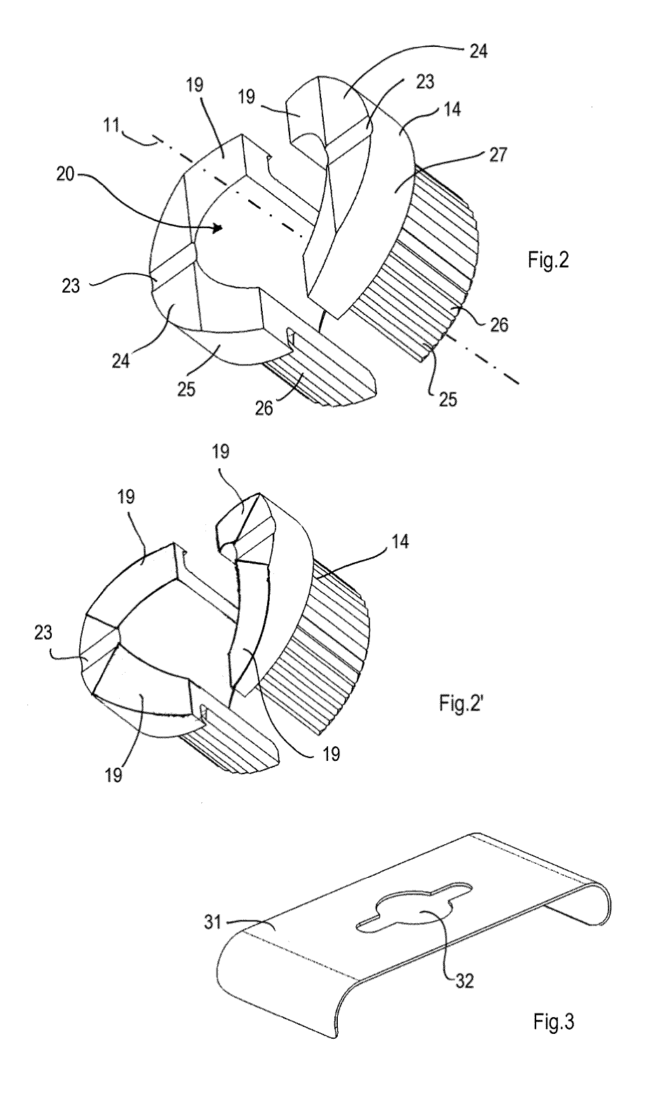

Accordingly, the opening 7, in a version, is so shaped as to allow insertion and passage of the pressing-clamping-end 9 therethrough when the pin-group 6 is arranged in a set angular position as shown in FIG. 1.

The connecting device 1 comprises a locking-positioning-arrangement 14 configured for keeping the pressing-clamping-end 9 blocked in the locking-clamping-position 16. The locking-positioning-arrangement 14 is configured for imparting to the pressing-clamping-end 9, upon a rotation of the pin-group 6—by acting on the head end 10—from the releasing position 15 to the locking-clamping-position 16, a tightening displacement 17 which generates a tightening force pressing the mutually overlapping first and second portions against to one other.

The head-end 10 is shaped for being rotated by an ordinary spanner tool. However, the head-end 10 can be configured with a desired shape so that it can be rotated by a dedicated rotating tool.

The locking-positioning-arrangement 14 is shaped for being placed at an opposite side with respect to the head end 8. In the example shown in the Figures, the locking-positioning-arrangement 14 is applied on the second portion of the stationary conducting terminal 4.

The locking-positioning-arrangement 14 comprises one or more ramp-shaped surfaces 19 which are shaped for forcing the pressing-protrusions 18 to follow a path having a movement-component parallel to the longitudinal axis 11. In other words, upon a rotation of the pin-group 6, the pressing-protrusions 18 slide on the ramp-shaped surfaces 19 and are forced by the latter to move along a direction away from the connection-region 10. Each pressing-protrusion 18 follows a path which is composed by a circular component—due to the rotation around to the longitudinal axis 11—and by a longitudinal component oriented parallel to the longitudinal axis 11. Therefore, from the releasing position 15 to the locking-clamping-position 16, the pressing-protrusions 18, and therefore the whole pressing-clamping-end 9, are subjected to the tightening displacement 18, directed along the longitudinal axis 11, as shown in FIG. 5.

The locking-positioning-arrangement 14 comprises a passage-opening 20 which is shaped for enabling a passage of the pressing-clamping-end 9 only when the latter is in the releasing position 15. The passage-opening 20 is shaped according to the cross-section-profile of the pressing-clamping-end 9. In particular, the passage-opening 20 comprises a central circular-opening-zone, traversable by the free end of the pin body, and a pair of side slot-opening-zones which are traversable by the pressing-protrusions 18.

The locking-positioning-arrangement 14, in all the exemplary and non-limitative versions described and shown, comprises a pair of ramp-shaped surfaces 19, in particular, arranged mutually symmetrically with respect to a longitudinal plane containing the longitudinal axis 11. The two ramp-shaped surface 19 are tilted so as to mutually converge according to a direction pointing to an internal zone of the connection-region 10, when the locking-positioning-arrangement 14 is mounted on the first portion 2.

The ramp-shaped surfaces 19 lye on planes which are tilted by an acute angle 21 with respect to a median plane 22, as shown in FIG. 9, and ranging, for example from 10° to 45°.

Such an acute angle 21 is suitably chosen in function of the tightening displacement 17 which is required to obtain the desired value of tightening-contact-pressure, taking into account geometrical dimensions and elastic stiffness of the pin-group 6, in particular of the stem-portion 12, and of the locking-positioning-arrangement 14.

The configuration of the ramp-shaped surfaces 19 and of the pressing-protrusions 18 as above described enables the connecting device 1 to be quickly switched from the releasing position 15 to said locking-clamping-position 6 and vice versa simply by rotating the pin-group 6 by only 90° degrees either clockwise or counterclockwise.

According to a version (shown in FIG. 2′), the ramp-shaped surfaces 19 have a helical-shape-configuration, instead of a plane shape as above described.

The locking-positioning-arrangement 14 comprises locking-recess-zones 23 for housing and keeping the pressing-protrusions 18 locked in the locking-clamping-position 16.

In particular, the locking-recess-zones 23 are obtained on rest-surfaces 24 lying on a plane orthogonal to the longitudinal axis 11.

The locking-positioning-arrangement 14 is made of a material with high mechanical properties, such as a tempered steel material.

The locking-positioning-arrangement 14 may have a bush shape, and can be configured as a single-piece element or can be defined by two half-bodies. In a first version shown in FIGS. 1, 2, 4 and 5, the locking-positioning-arrangement 14 is defined by two distinct half-bush-bodies 25. The half-bush-bodies 25 comprise a keying-portion 26 shaped for being inserted with mechanical interference into the opening 7 so as to result in a stationary position, and a crown portion 27 on which the ramp-shaped surfaces 19 are provided. The half-bush-bodies 25 can be inserted in the opening 7 using a dedicated tool.

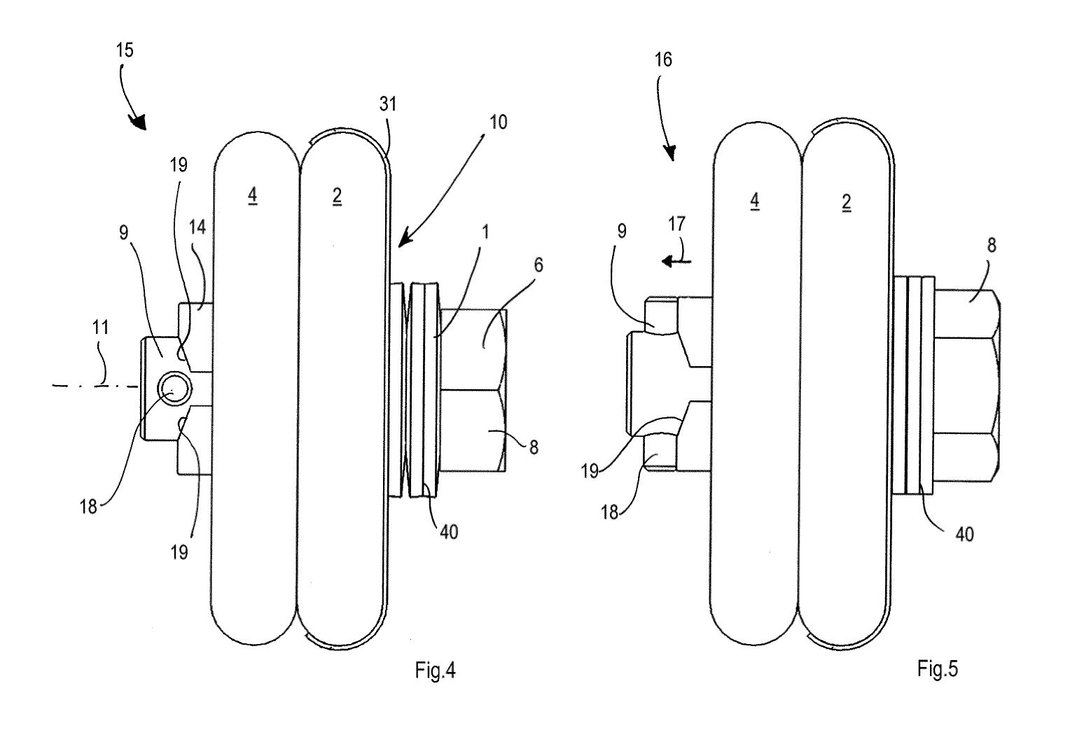

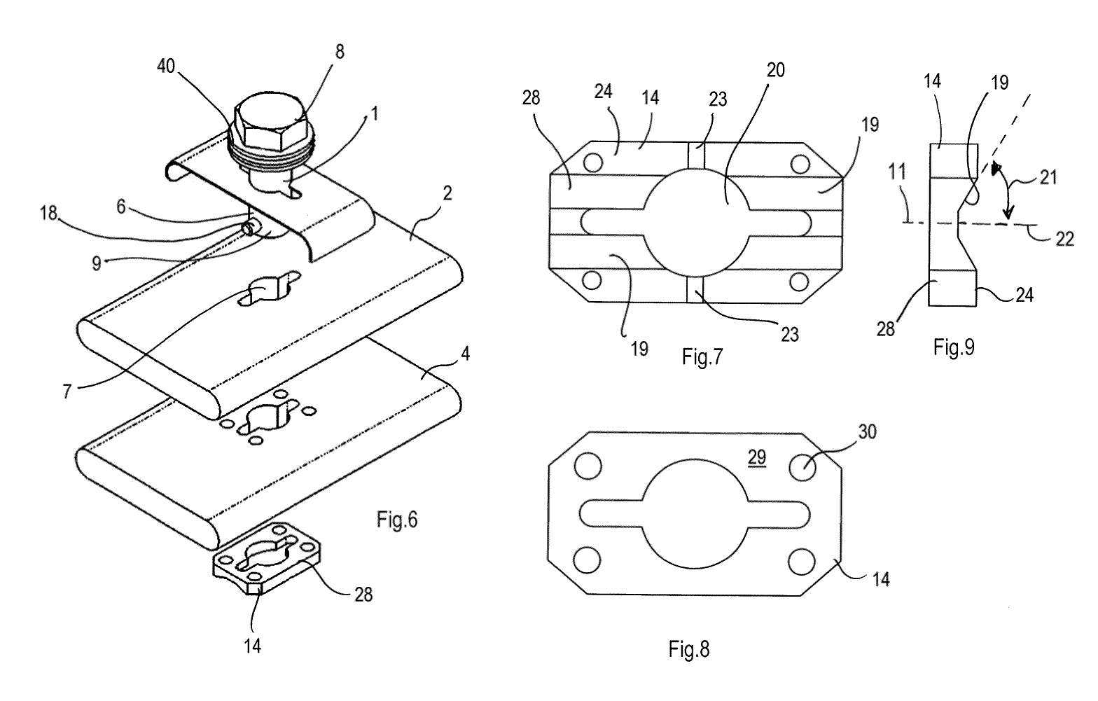

According to a further version (shown in FIGS. 6 to 9), the locking-positioning-arrangement 14 comprises a plate element 28 having a plane-connection-surface 29 which is at an opposite side with respect to the ramp-shaped surfaces 19 and is suitable for being applied on the portion of the stationary conducting terminal 4. The plate element 28 can be fixed to the stationary conducting terminal 4 for example by screw-elements, trough the apposite fixing holes 30, or by other connection types, such as welding, brazing etc.

The connecting device 1 is provided with a tightening-control-arrangement 40 configured for controlling the tightening force so as to achieve a desired required value of tightening-contact-pressure between the mutually overlapping portions of the movable 2 and stationary 4 conducting terminals.

In the exemplary and non-limitative versions shown, the tightening-control-arrangement comprises a spring element 40 interposable between the head-end 8 and the mutually overlapping portions. The spring element in particular comprises a Belleville-washer-spring 40 configured for urging the head-end 8 away from the connection region 10 so as to generate the desired tightening force upon the tightening displacement 17 imparted to the pressing-clamping-end 9.

During functioning, when the head-end 8 is rotated from the releasing position 15 to the locking-clamping-position 16, the pressing-protrusions 18 slide on the ramp-shaped surfaces 19 and shift the entire pin-group 6 along the longitudinal axis 11 by the tightening displacement 17. The Belleville-washer-spring 40, thus compressed, exerts a counter-pushing-action on the head-end 8 which achieves the desired contact-pressure between the mutually overlapping portions.

In a further version (not shown) the connecting device 1 is devoid of a spring element, and in this case the tightening-control-arrangement is provided by suitably configuring the stem portion 12 so as to achieve a determined longitudinally elastic stiffness which enables to achieve the desired tightening force in the locking-clamping-position. The shape, dimensions and elastic stiffness of the stem portion 12, combined with the shape and orientation of the ramp-shaped surfaces 19 enable to obtain the desired tightening force corresponding to a set tightening-displacement 17 of the pressing-clamping-end 9.

Owing to the tightening-control-arrangement 40, the clamping procedure is very fast since an operator does not need to perform control-torque-procedures as occurs in the prior art devices. The adequate value of tightening-contact-pressure between the mutually overlapping portions is automatically ensured by the tightening-control-arrangement 40 in a safe and reliable way.

The Belleville-washer-spring 40 is made of a spring steel material, and is designed with a suitable dimension and stiffness parameters in such a way to achieve the desired tightening-contact-pressure in the connection region 10, in order to ensure an effective transfer of electrical current between the movable 2 and stationary 4 conducting terminal.

The connecting device 1 further comprises an anchor-plate-element 31 which can be elastically snap-fitted or fixed to a zone, in particular to one of the two mutually overlapping portions for preventing a separation of the pin-group 6 therefrom also when the pin-group 6 is in the releasing-position 15. The anchor-plate-element 31 has an insertion-opening 32 which is shaped according to the cross-profile of the pressing-clamping-end 9, and like the opening 7. When the anchor-plate-element 31 is coupled to the respective conducting terminal portion, the insertion-opening 32 is angularly staggered with respect to the opening 7 of the mutually overlapping portions of conducting terminals, and in this way an extraction of the pressing-clamping-end 9 is not allowed.

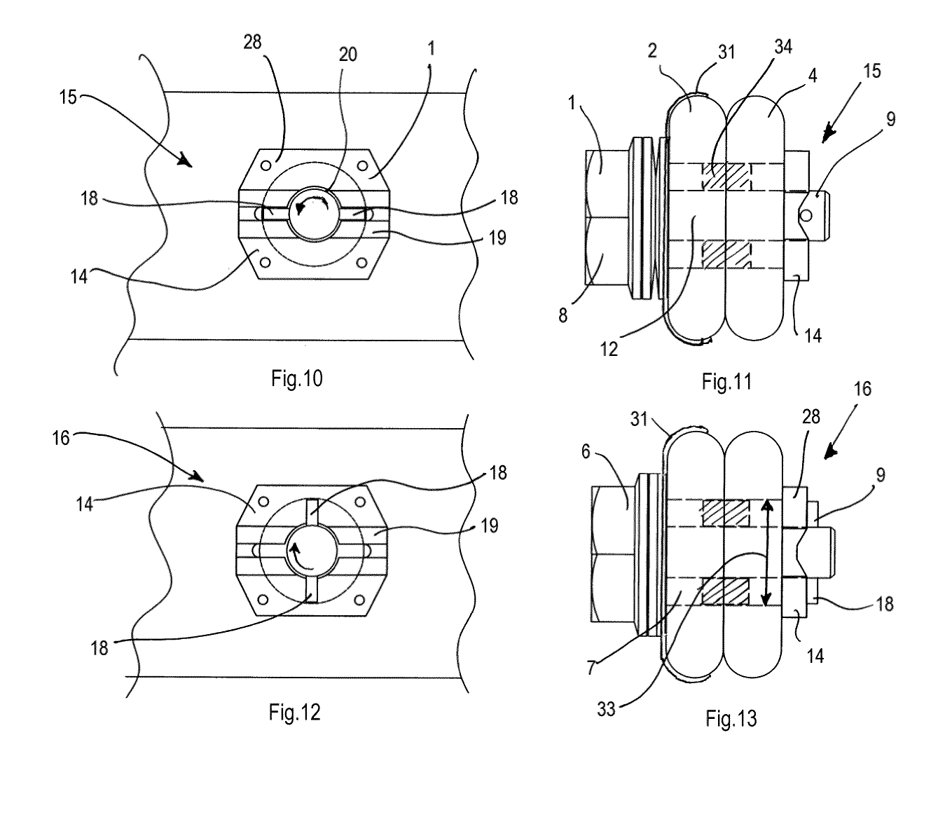

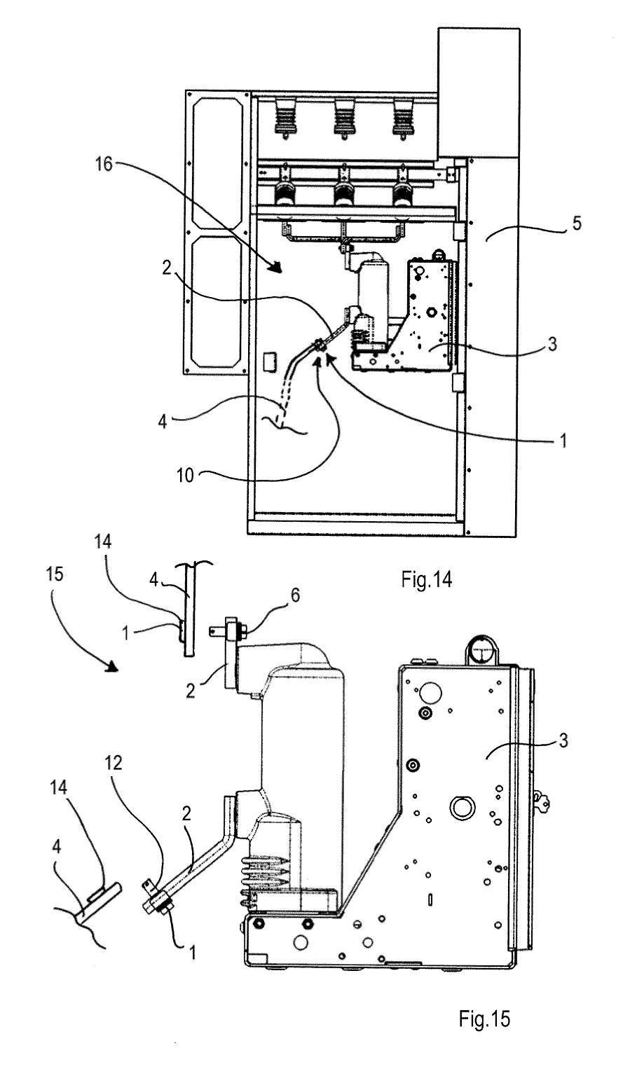

FIGS. 10 to 12 shows a further version of the connecting device 1 analogous to the version of FIGS. 6 to 8, but with some differences. In this case, the plate element 28 and the pressing-clamping-end 9 have a shape configuration such that it is sufficient to have an opening 7, through the mutually overlapping portions, having a simple cylindrical shape. This simplifies and makes easier the assembling operations of the connecting device 1 on the conducting terminals.

In other words the diameter 33 (shown in FIG. 13) of the opening 7 in this case is equal or slight greater than the maximum transverse dimension of the pressing-clamping-end 9, including the pressing-protrusions 18. A suitable spacer-washer 34 can be arranged around the stem portion 12 for keeping the pin-body in a correct central position and to prevent separation of the pin-group 6 from the movable conducting terminal 2 in the releasing position 15.

The connecting device 1 has been above described with the locking-positioning-arrangement 14 connected the stationary conducting terminal 4, and with the anchor-plate-element 31 and the pin-group 6 applied to the movable conducting terminal 2. Of course, such two arrangement positions can be exchanged with one other.

It is evident, from the above description, that the connecting device 1 combines the advantages of a bolts-nuts connection device (i.e. reliability, cheapness and structural simplification) with the advantages of a pliers/tulips connection device (i.e. ease of connection/disconnection), but at the same time enables to overcome the above stated drawbacks of such prior art connection devices.

The connecting device 1 guarantees a defined contact-pressure between the two mutually overlapping portions, with no need for torque control procedures at all, and enables to connect and disconnect the busbar terminal in a faster way than the bolts-nuts connection device of the prior art. Furthermore, the connecting device 1 is structurally simple and the cost for producing it is comparable with that of a bolts-nuts connection device of the prior art.

The connecting device 1 is susceptible of modifications or variations all within the scope of the inventive concept as defined by the appended claims; any details may be replaced with technically equivalent elements.

One or more of the elements above described may be differently shaped and/or positioned, can be realized in one or more pieces and/or can be differently coupled or positioned, etcetera.

The materials, so long as they are compatible with the specific use, as well as the individual components, may be any according to the requirements and the state of the art.

1-16. (canceled)

17. A connecting device suitable for connecting a movable conducting terminal of a switching device to a stationary conducting terminal of a switchgear apparatus, comprising:
a pin-group suitable for being inserted into an opening obtained in a connection-region which is defined by mutually overlapping portions of said movable and stationary conducting terminals,
said pin-group having a head-end and a pressing-clamping-end which are suitable for being positioned at opposite sides with respect to said connection-region, said pin-group being movable from a releasing position, in which a mutual separation of said movable and stationary conducting terminals is enabled, to a locking-clamping-position, in which said movable and stationary conducting terminals are reciprocally clamped, wherein it further comprises
a locking-positioning-arrangement configured for keeping said pressing-clamping-end blocked in said locking-clamping-position and for imparting to said pressing-clamping-end, upon a movement of said pin-group from said releasing position to said locking-clamping-position, a tightening displacement so as to generate a tightening force which presses said mutually overlapping portions against to one other, and
a tightening-control-arrangement configured for controlling said tightening force so as to set a desired value of tightening-contact-pressure between said mutually overlapping portions.

18. The connecting device according to claim 17, wherein said pin-group comprises a pin-body for being inserted into said opening, said pin-body having a longitudinal axis intended to be arranged parallel to an axis of said opening along a clamping direction, said pressing-clamping-end comprises a pressing-protrusion-arrangement extending transversely with respect to said longitudinal axis, and wherein said locking-positioning-arrangement is shaped for being placed on a first portion of said mutually overlapping portions at an opposite side with respect to said head end and comprises one or more ramp-shaped surfaces which are adapted so as to force said pressing-protrusion-arrangement to follow a path having a displacement-component parallel to said axis.

19. The connecting device according to claim 18, wherein said locking-positioning-arrangement comprises a passage opening which is shaped for enabling a passage of said pressing-clamping-end only in said releasing position, said pressing-protrusion-arrangement comprises two pressing-protrusions extending transversely from said pin-body in opposite directions, and said ramp-shaped surfaces comprise two ramp-shaped surfaces for cooperating with said pressing-protrusions.

20. The connecting device according to claim 18, wherein said ramp-shaped surfaces are arranged mutually symmetrically with respect to a longitudinal plane containing said longitudinal axis, and mutually converge according to a direction which, in a mounted configuration of said locking-positioning-arrangement on said first portion, points towards an internal zone of said connection-region.

21. The connecting device according to claim 18, wherein said ramp-shaped surfaces extend with a helical-shape-configuration.

22. The connecting device according to claim 18 wherein said pressing-protrusions extend at opposite sides from said pin-body and are mutually aligned along a common extending direction, wherein a positioning from said releasing position to said locking-clamping-position and vice versa is achievable through a rotation by 90° of said pin-group.

23. The connecting device according to claim 18, wherein said locking-positioning-arrangement comprises locking-recess-zones for housing and keeping said pressing-protrusion-arrangement in said locking-clamping-position.

24. The connecting device according to claim 23, wherein on said locking-positioning-arrangement there are obtained rest-surfaces lying on a plane orthogonal to said longitudinal axis, said locking-recess-zones being obtained on said rest-surfaces.

25. The connecting device according to claim 18, wherein said locking-positioning-arrangement comprises a bush element, configured as a single-piece or defined by two half-bodies, said bush element having a keying-portion shaped for being inserted into said opening in a stationary position, and a crown portion on which said one or more ramp-shaped surfaces are provided.

26. The connecting device according to claim 18, wherein said locking-positioning-arrangement comprises a plate element having a plane-connection-surface for being applied on said first portion, said ramp-shaped surfaces being provided on an opposite side with respect to said plane-connection-surface, said plate element being connectable to said first portion through a screwing element.

27. The connecting device according to claim 17, wherein said tightening-control-arrangement comprises a spring element interposable between said head-end and said mutually overlapping portions and configured for urging said head-end away from said connection region in such a way that the desired tightening force is achieved in correspondence of said tightening displacement imparted to said pressing-clamping-end.

28. The connecting device according to claim 27, wherein said spring element comprises a Belleville-washer-spring.

29. The connecting device according to claim 17, wherein said tightening-control-arrangement is provided by a longitudinally elastic stem portion of said pin-group, suitably configured with such a shape, dimensions and an elastic stiffness as to obtain the desired tightening force upon said tightening displacement imparted to said pressing-clamping-end.

30. The connecting device according to claim 17, further comprising an anchor-plate-element which can be snap-fitted or fixed to a second portion of said mutually overlapping portions for preventing a separation of said pin-group from said second portion also in said releasing-position, said anchor-plate-element having an insertion-opening for engaging with said pin-group.

31. A kit comprising a connecting device according to claim 17, and conducting terminals, of the busbar type, for the electrical connection of a removable switching device within a switchgear apparatus, wherein on said conducting terminals there are obtained openings for receiving said pin-group.

32. A switchgear apparatus comprising a circuit breaker having a conducting terminal movable therewith, and a stationary conducting terminal, wherein it further comprises at least one connecting device according to claim 17 for connecting said stationary conducting material with said conducting terminal movable with the circuit breaker.
